(19) United States
(12) Patent Application Publication
(10) Pub. No.: US 2005/0219044 A1
(43) Pub. Date: Oct. 6, 2005

(54) Emergency, contingency and incident management system and method

(75) Inventors: John Douglass, Bendigo (AU); David Wallis, Bendigo (AU); Nathan Martyn, Bendigo (AU); Aaron Pearse, Croydon (AU)

Correspondence Address: MOETTELI & ASSOCIATES SARL, ST. LEONHARDSTRASSE 4, 9000 ST. GALLEN, CH

(73) Assignees: Science Traveller International Inc, Seattle, WA (US); Science Traveller International Pty. Ltd., Bendigo (AU)

(21) Appl. No.: 11/082,189

(22) Filed: Mar. 16, 2005

Related U.S. Application Data
(60) Provisional application No. 60/553,130, filed on Mar. 16, 2004.

(51) Int. Cl. G08B 29/00

(52) U.S. Cl. 340/506; 379/49; 340/628; 340/531; 709/223

(57) ABSTRACT

A software system and associated method implements real-time management of events such as emergencies, contingencies and incidents by responding to user inputs and environmental detectors, carrying out defined and custom procedures, establishing communications channels with key personnel and emergency services, maintaining an audit trail of events, broadcasting appropriate instructions, tasks and graphical information to personnel, and providing monitoring, recording and communication facilities for local and/or remote coordinators and command centers.

### BACKGROUND OF THE INVENTION

The invention relates to systems and protocols for handling of incidents, emergencies and contingencies through the use of local and remote computing resources and communications networks.

Currently, procedures for the handling of emergencies, contingencies and incidents are generally documented in written documents and organizational policies for use by staff, emergency services and key personnel during such events. These procedures outline the steps required to prevent or minimize risk of injury to personnel and damage to property, and also outline the requirements to comply with various civil and legal responsibilities during the handling of such events.

During emergency events, contingencies and incidents, designated personnel and emergency services are required to follow these procedures manually. Tasks outlined in such procedures include establishing communications channels, providing personnel with relevant advice and assistance, directing personnel and emergency services, assigning tasks, locating personnel, monitoring progress of assigned tasks and recording events.

Therefore, a need exists for an apparatus and associated method for use with local and remote computing and communications resources, that can electronically implement these procedures.

### SUMMARY OF THE INVENTION

A computer network system (including local and remote computers and communication devices), that, in response to user inputs (e.g. including but not limited to, notifications of fire, threatening behavior, assault, civil disturbance, bomb, medical assistance, hazardous material, personnel danger, property or security risks, evacuation and training exercise alerts, etc. and including unquantifiable alerts e.g. glass breaks, duress etc.) and/or electronic inputs from devices such as monitors and detectors (e.g. including but not limited to monitors/detectors of temperature, wind, water, earthquake, fire, power failure, gas, cyber attacks etc.), performs the steps of (1) initiating an electronic implementation of single or multiple procedures appropriate for the management and handling of such incidents and (2) establishing multiple targeted communication channels (simplex, duplex and broadcast) to assign tasks, respond to inputs and maintain a detailed log of all related events. The system is designed to perform the monitoring and electronic implementation of such procedures according to a defined methodology.

An object of the invention is to significantly increase response rates to emergency and contingency events, to speed the dissemination of key and crucial information and task assignment between personnel and emergency services, and assisting in complying with civil and legal requirements during the handling of such events, as well as providing an electronic log of events for training exercises and post-event analyses and review.

### BRIEF DESCRIPTION OF THE DRAWINGS

FIG. 1 is a block diagram of the system of the invention.

FIG. 2 is a block diagram of the server component of the system of the invention.

FIG. 3 is a block diagram of the client component of the system of the invention.

FIG. 4 is a block diagram of an embodiment of the invention, termed an alert state machine.

FIG. 5 is a block diagram of a gas leak alert of the invention.

### DETAILED DESCRIPTION OF THE PREFERRED EMBODIMENT

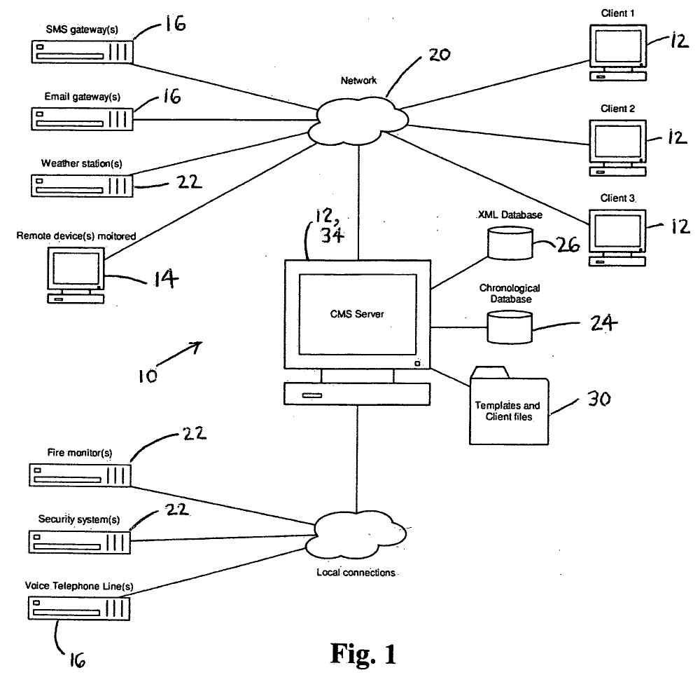

Referring now to FIG. 1, a computer network system 10, including local and remote computers 12 and 14, respectively, and communication devices 16 connected in a network 20 is provided that, in response to user inputs (e.g. including but not limited to, notifications of fire, threatening behavior, assault, civil disturbance, bomb, medical assistance, hazardous material, personnel danger, property or security risks, evacuation and training exercise alerts, etc. and including unquantifiable alerts e.g. glass breakage, duress etc.) and/or electronic inputs from devices such as monitors 22 and detectors (e.g. including but not limited to, temperature, wind, water, earthquake, fire, power-fail, gas detectors, cyber attacks etc.), initiates an electronic implementation of single or multiple procedures appropriate for the management and handling of such incidents and establishes multiple targeted communication channels (simplex, duplex and broadcast) to assign tasks, respond to inputs and maintain a detailed log of all related events in a chronological database 24. A main database 26 stores other information necessary to system operation. Local storage 30 stores templates and client files.

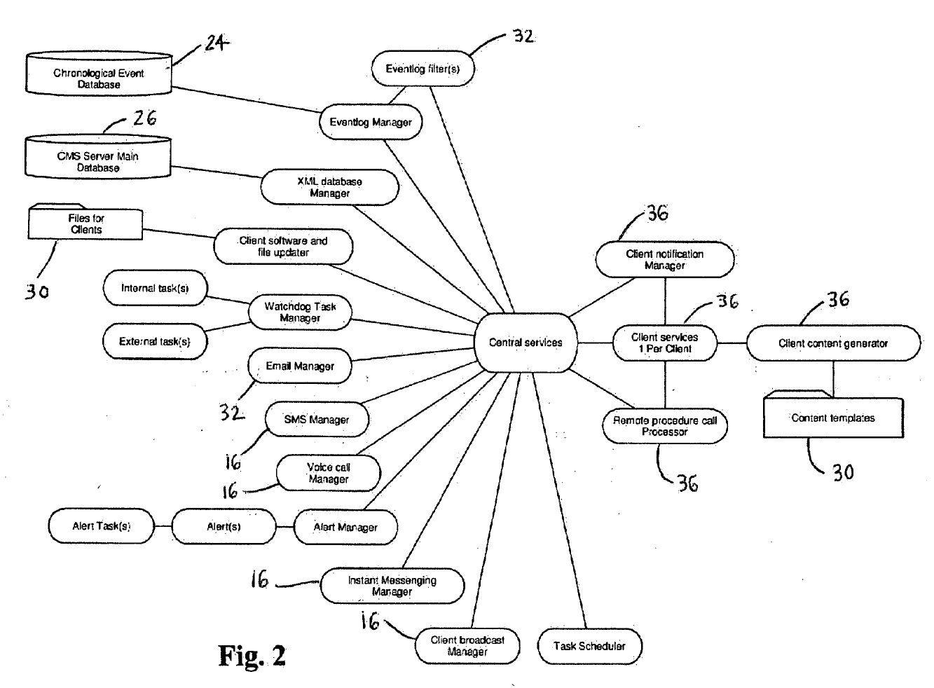

In the preferred embodiment, as shown in FIG. 2, the system 10 of the invention includes one or more centralized server software modules 32 installed on a network computer 34, and multiple client software modules 36 installed or downloaded on demand for administrator, user, staff, coordinator and emergency service personnel computers (local or remote to the server computer). Various implementations of the client software modules 36 exist, providing functionality specific to various job roles or responsibilities during incidents.

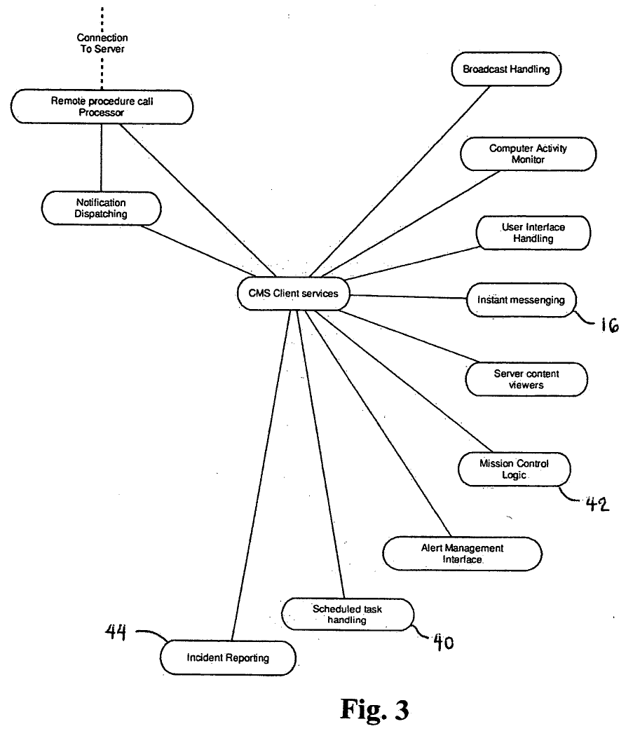

Referring now to FIG. 3, client and Server modules communicate by standard computer network protocols (e.g. TCP/IP, wireless networks etc.) using proprietary encrypted communications and authenticated login.

Various implementations of the client software modules exist, providing functionality specific to various job roles or responsibilities during incidents. Additional functionality for client modules can be downloaded remotely from the server module at login time, depending on the job role and nature of incidents.

Records of all Contingency Management System (“CMS”) operation, inputs and communications are maintained in a chronological database (CMS EventLog) 24 which is optimized to facilitate provision of specific event information (termed CMS Event Watches) for local or remote personnel use during incidents—according to attributes including but not limited to: person, group, location, type, action, role and time.

An extensive range of built-in software functions are provided by the CMS system, to allow an administrator to implement an organization's existing written response procedures and organizational policies for automated operation during emergencies, contingencies and incidents. These response procedures can be triggered by user inputs from personnel (via PC and communication devices) and/or electronic sensors, or programmed at random or scheduled times for compliance or exercise purposes, and can optionally require incident authentication by authorized coordinators within a specified time frame, or proceed automatically.

Functions available to implement such response procedures and policies include (but are not limited to), means to assign tasks 40, monitor progress and issue directives 42, provide status 44 and geographical information to specific groups of personnel (local and remote). Example procedures which administrators can tailor to organization requirements include: fire, threatening behavior, assault, civil disturbance, bomb, medical assistance, hazardous material, personnel danger, property or security risks, evacuation and training exercise alerts, etc. and including unquantifiable alerts (e.g. glass breakage, duress etc.).

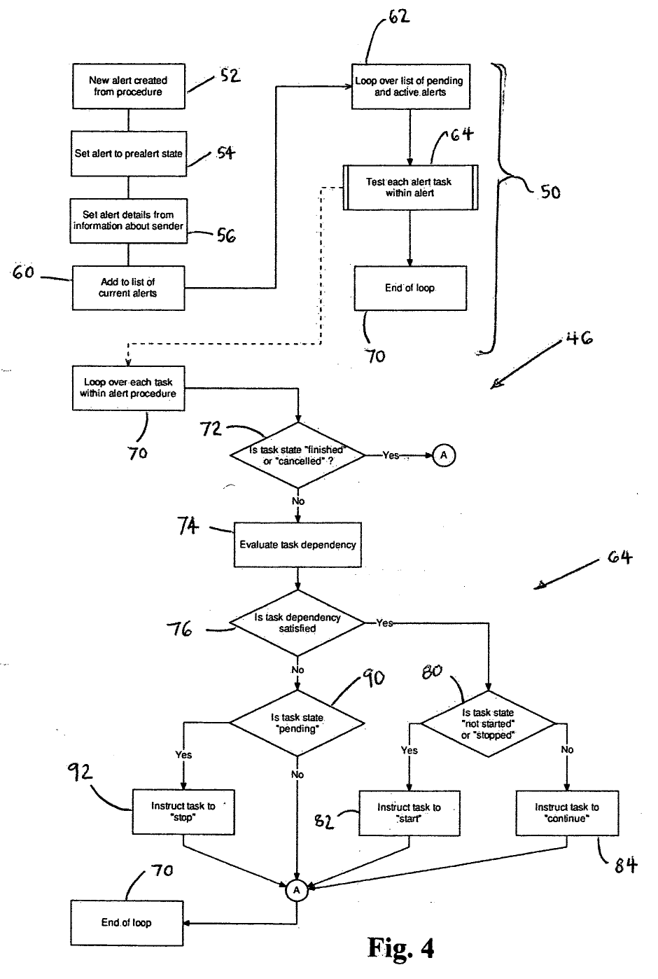

Referring now to FIG. 4, an alert state machine 46 includes subroutines 50 for alert state input, definition and handling procedure permits new alerts to be added to a list of alerts and related tasks to be managed. The subroutine 50 includes a number of steps. In a first step 52, a new alert is created from a procedure. In a second step 54, the alert is set to a prealert state. In a third step 56, using information about sender as input, alert details are set. In a fourth step 60, the alert is added to a list of current alerts. In a fifth step 62, the subroutine 50 loops over the list of pending and active alerts. In a sixth step 64, each alert task within alert is tested. In a seventh step 66, the loop ends.

The sixth step 64 is made up of several substeps, which loop over each task within the alert procedure in loop 70. In a first substep 72, a logical or gate verifies whether the task state is finished or cancelled and if “yes”, then the subroutine ends, otherwise, in substep 74, the task dependency of the alert is evaluated. In a substep 76, a logical or gate checks whether the task dependency is satisfied. If yes, in a sixth substep 80, a logical or gate checks whether the task state is “not started” or “stopped”, and if task is “not started”, in a seventh substep 82, the task is instructed to “start”, and then the subroutine ends, otherwise, in block 84, the task is instructed to continue, and the subroutine and loop 70 ends (loop execution completes), after the last alert task is executed. Otherwise, in substep 90, the subroutine 46 checks whether the task state is “pending” and if yes, in substep 92, the task is instructed to “stop”, otherwise if task state is not “pending”, the subroutine and loop 70 ends.

The drawing uses the convention of an “A” in a circle to indicate that the process (logic path) ends/terminates (ie. there is nothing more to be done for the task). In other words, if an alert has 10 tasks to be executed, the logic of FIG. 4 will be performed 10 times for each specific task.

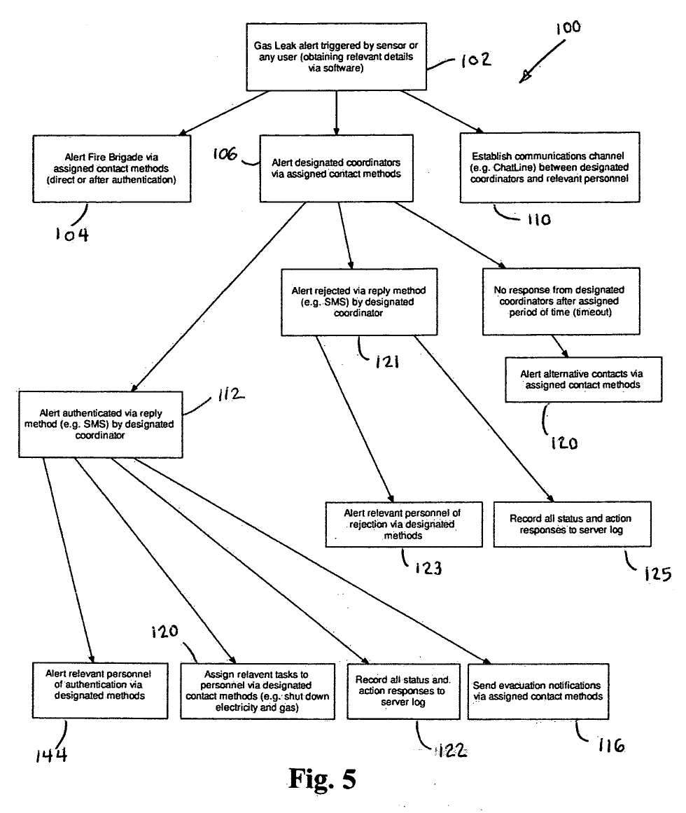

Referring now to FIG. 5, an illustration of an example of operation 100 of this system 10 is shown, and should be compared to conventional handling of such incidents in an organization by personnel following a written document:

Example of Use: Gas leak

In the event of a gas leak, in block 102, any person within an organization on suspecting a gas leak can click on a CMS system desktop ‘Incident’ icon and instantly generate a ‘gas leak’ alert—along with any details known to them for which the software prompts them for inputs. This triggers the CMS Server software module to begin executing a software response procedure (previously created by the system administrator) based on a documented organizational response procedure for such an incident (gas leak).

A company procedure may require the step 104 of immediate notification of the fire brigade and/or the step 106 of alerting designated organization coordinators via assigned contact methods, and/or the step 110 of the establishment of communication channels with emergency services and coordinators, request for commencement of emergency procedures from authorized site personnel, issuance of evacuation notifications to personnel in the vicinity, establishment of an emergency ‘Command Centre’, notifications to relevant departments to commence shut down of air conditioning systems, electricity and gas, recording of events, assignment of staff to direct emergency services, and maintenance of communication channels with emergency services and coordinators until the incident is resolved.

In one embodiment, the CMS server implements the above response procedure in software form according to the following steps. In the step 104, the fire brigade and coordinators are sent initial incident alerts as required (by phone, SMS, PC and any other designated communication mechanisms), with immediate confirmation of receipt requested. In the step 110, a communication channel with coordinators and relevant personnel is established via secure instant messaging, from a ‘Command Center’ computer (which can be established on any local or remote computer via login to the CMS server), and incident details are broadcast concurrently to all relevant personnel. In the step 106, the designated coordinators are alerted via assigned contact methods. The opportunity is given to any authorized coordinator to confirm “authentication”, in step 112, or reject ‘authentication’ of the incident, in step 114, to the CMS server, and, in block 116, if such coordinator is absent or if outside of normal business hours, then in step 120, an alternative automated procedure, such as trying alternative contact phone numbers. Similarly, in the event of false alarms, in step 121, the alert can be rejected via a reply method by a designated coordinator, wherein, in step 123, relevant personnel are alerted of rejection via designated methods and further, in step 125, all status and action responses are recorded to server log, this information is rapidly distributed to all relevant personnel using the incident communication channel and all other designated communication devices for those personnel. In the step 112, if the gas leak incident is authenticated, the CMS response procedure may then, in step 114, alert relevant personnel of authentication via designated methods, or in step 116, broadcast evacuation notifications, by phone, SMS, PC flashing screen, and any other designated communication mechanisms, to all staff in vicinity of the incident area, also, in step 120, requesting electrical devices be switched off and automatically assigning tasks and communicated to relevant personnel for shut down of air conditioning systems, electricity and gas, and directing assisting emergency services (e.g. fire brigade). In a step 122, from any designated ‘Command Center’ computer station, authorized personnel are able to monitor outstanding, unacknowledged and completed tasks, generate new tasks and notifications for personnel (by name, group, role, location etc.), add log notes for prescribed events, review the status of relevant building detectors (if available), confirm evacuation checkpoint lists and broadcast status messages and requests as required to other personnel, until the incident is resolved.

The system is designed to perform the monitoring and electronic implementation of single or multiple procedures appropriate for the management and handling of such incidents according to any one of several methods.

In an embodiment, the system continually monitors for user inputs relating to a possible incident from any associated network computer or communication device, as well as electronic inputs which may predict a possible future adverse incident, emergency or contingency situation. Any inputs received can trigger, an electronic implementation of one or more incident procedures appropriate to these inputs.

Incident procedures can be defined, modified and stored to programmatically perform a range of sequential and/or concurrent tasks including but not limited to: dissemination of notifications, tasks, instructions and status information to personnel by name, group, role and location.

Instructions, tasks, notifications, status and geographical information (such as, but not limited to, evacuation points, contingency and personnel locations) can be automatically initiated and broadcast or targeted to specific groups of personnel (local and remote).

Bi-directional communication channels are automatically established with staff, key personnel and, emergency services using a range of mechanisms including but not limited to: phone, paging, SMS, radio, email, internet and user computers, and additionally used to monitor the status of tasks assigned to relevant personnel and call additional procedures based on such responses.

Locations of personnel and the status of building detectors and access points can be remotely monitored to assist in maximizing personnel safety during incidents, along with the flexibility to incorporate future hardware devices and detection systems through use of an extensible modular software architecture.

Locations of personnel may be monitored using infrared counting devices such as that described in U.S. Pat. No. 6,407,389 to Nishii et al, the content of which is incorporated herein by reference thereto. In an alternative monitoring device, optical patter recognition devices may be used to monitor personnel within a building, the principles of which are described in U.S. Pat. No. 5,845,000, the content of which is incorporated herein by reference thereto.

All system status and events prior to and resulting from the electronic implementation of incident procedures are maintained in real-time in a chronological database (designated the EventLog), along with inputs and status information logged electronically by personnel, for local and remote access by authenticated users.

Event entries in the chronological database (EventLog) are filtered in real-time upon demand according to user requirements, by a range of attributes including but not limited to person, group, location, type, action, role and time, and communicated locally and remotely to assist key personnel and emergency services in rapidly isolating specific information and events.

Training, preparedness and compliance (legal and organizational) for the handling of incidents by personnel can be initiated and evaluated at predetermined and/or random times through the use of questionnaires, checklists, diagnostics and incident simulations.

A method whereby graphical, video and binary data of use during such incidents can be securely communicated between authenticated key personnel and emergency services if required to maximize personnel safety, without the limitations imposed by the day-to-day administration and security restrictions utilized on standard organizational computer network systems.

In a feature of the invention, the design of the client/server communications has been optimized based on prioritization of the data, its role and recipients during such incidents.

In an advantage of the invention, use of such a method is likely to significantly increase response rates to emergency and contingency events, to speed the dissemination of key and crucial information and task assignment between personnel and emergency services, and assisting in complying with civil and legal requirements during the handling of such events, as well as providing an electronic log of events for training exercises and post-event analyses and review.

In another advantage, the invention leverages the current technological computing hardware and communications facilities now available to most organizations, to provide a rapid, effective, flexible and cost-effective approach to the automated handing of emergencies.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

### ADDENDUM

The specifications, minus the claims, of the following references are incorporated herein by reference and relied upon:

| | |
|---|---|
| United States Patent Application | 20040264661 |
| Title: | Emergency alert notification system and |
| | method |
| Harris, Shane | Dec. 30, 2004 |
| United States Patent Application | 20050001720 |
| Title: | Emergency response personnel |
| | automated accountability system |
| Mason, Charles; et al. | Jan. 6, 2005 |
| United States Patent | 6,839,552 |
| Title: | System and method for reporting an |
| | emergency situation |
| Martin | Jan. 4, 2005 |
| United States Patent Application | 20050006109 |
| Title | Transmission of data to emergency |
| | response personnel |
| McSheffrey, Brendan T.; et al. | Jan. 13, 2005 |
| United States Patent Application | 20050013418 |
| Title | Emergency notification systems |
| Chang, Shye-Bin; et al. | Jan. 20, 2005 |
| United States Patent Application | 20050031102 |
| Title | System and method of providing |
| | emergency response to a user |
| | carrying a user device |
| Kraus, Mark W.; et al. | Feb. 10, 2005 |
| United States Patent Application | 20050034075 |
| Title | GIS-based emergency management |
| Riegelman, Edward A.; et al. | Feb. 10, 2005 |
| United States Patent Application | 20050037728 |
| Title | Emergency broadcast message in a |
| | wireless communication device |
| Binzel, Charles P.; et al. | Feb. 17, 2005 |
| United States Patent Application | 20050048945 |
| Title | Emergency call system and method |
| Porter, Robert | Mar. 3, 2005 |
| United States Patent Application | 20050055245 |
| Title | Hospital and clinic emergency |
| | preparedness optimization system |
| Oster, Neill S.; et al. | Mar. 10, 2005 |
| United States Patent Application | 20040267685 |
| Title | Storage container for emergency |
| | information and method of assisting |
| | rescue personnel |
| Sharland, Thomas G.; et al. | Dec. 30, 2004 |

1. A computer-readable method encoded one a computer readable medium, the method executable on a system and including the steps of:
(a) receiving an input selected from one of a group of inputs consisting of notifications of fire, threatening behavior, assault, civil disturbance, bomb, medical assistance, hazardous material, personnel danger, property/security risks, evacuation, training exercise alerts, glass breakage alert, duress alert, monitor alerts, detector alerts, and, in response thereto,
(b) initiating an electronic implementation of at least one procedure appropriate for the management and handling of such incidents, and
(c) establishing multiple targeted communication channels selected from a group of channels consisting of simplex, duplex and broadcast, to assign tasks, respond to inputs and maintain a detailed log of related events.

2. The method of claim 1, further including the step of continually monitoring for user inputs relating to a possible incident from an associated network computer or communication device, as well as electronic inputs which may predict a possible future adverse incident, emergency or contingency situation.

3. The method of claim 1, wherein the method triggers an electronic implementation of one or more incident procedures appropriate to the inputs received.

4. The method of claim 1, wherein incident procedures are defined, modified and stored to programmatically perform a range of tasks selected from a group of tasks consisting of dissemination of notifications, assignment of tasks, and dissemination of instructions and status information to personnel by name, group, role and location.

5. The method of claim 4, wherein the tasks include tasks which are sequential.

6. The method of claim 4, wherein the tasks include tasks which are concurrent.

7. The method of claim 1, wherein, in the method, instructions, tasks, notifications, status and geographical information are automatically initiated and broadcast or targeted to specific groups of personnel.

8. The method of claim 1, including the following additional steps:
(a) automatically establishing bi-directional communication channels with staff, key personnel and emergency services using at least one mechanism selected from a group of mechanisms consisting of phone, paging, SMS, radio, email, internet and user computers, and
(b) monitoring the status of tasks assigned to relevant personnel and, based on responses received, calling additional procedures.

9. The method of claim 1, wherein devices monitor locations of personnel to assist in maximizing personnel safety during incidents, along with the flexibility to incorporate future hardware devices and detection systems through use of an extensible modular software architecture.

10. The method of claim 9, wherein further, devices monitor status of building detectors and access points to assist in maximizing personnel safety during incidents.

11. The method of claim 9, wherein the monitors are infrared counting devices.

12. The method of claim 9, wherein the monitors use optical recognition routines to count personnel.

13. The method of claim 1, wherein system status and events prior to and resulting from the electronic implementation of incident procedures are maintained in real-time in a chronological database, along with inputs and status information logged electronically by personnel, for local and remote access by authenticated users.

14. The method of claim 1, wherein event entries in the chronological database are filtered in real-time upon demand according to user requirements, by a range of attributes including but not limited to person, group, location, type, action, role and time, and communicated locally and remotely to assist key personnel and emergency services in rapidly isolating specific information and events.

15. The method of claim 1, wherein training, preparedness and compliance for the handling of incidents by personnel are initiated and evaluated through the use of questionnaires, checklists, diagnostics and incident simulations.

16. The method of claim 15, wherein the initiation and evaluation takes place at predetermined times.

17. The method of claim 15, wherein the initiation and evaluation takes place at random times.

18. The method of claim 1, wherein graphical, video and binary data of use during such incidents are securely communicated between authenticated key personnel and emergency services when required to maximize personnel safety.
